(19) United States
(12) Patent Application Publication
(10) Pub. No.: US 2026/0333043 A1
(43) Pub. Date: Oct. 22, 2026

(54) CONTENT ENCRYPTION FOR UNAUTHENTICATED STATIONS

(71) Applicant: Cisco Technology, Inc., San Jose, CA (US)

(72) Inventors: Ugo Mario Campiglio, Morges (CH); Domenico Ficara, Essertines-sur-Yverdon (CH); Stephen Michael Orr, Wallkill, NY (US); Jerome Henry, Pittsboro, NC (US); Javier I. Contreras Albesa, Sant Cugat del Valles (ES); Federico Lovison, Fontanelle (TV) (IT)

(21) Appl. No.: 19/574,672

(22) Filed: Mar. 23, 2026

Related U.S. Application Data
(60) Provisional application No. 63/792,368, filed on Apr. 22, 2025.

(51) Int. Cl. H04W 12/069; H04L 9/30; H04L 9/32

(52) U.S. Cl. CPC H04W 12/069; H04L 9/3066; H04L 9/3226

(57) ABSTRACT

Techniques that allow for sending encrypted data from an unauthenticated/unassociated wireless client device to an access point. In one embodiment, a method is provided that includes generating, by a wireless access point (AP), a cryptographic public key. The method includes providing, by the wireless AP, the cryptographic public key to an unauthenticated wireless client device. The method further includes receiving, by the wireless AP, from the unauthenticated wireless client device, a frame comprising data that was encrypted by the unauthenticated wireless client device using the cryptographic public key. This cryptographic public key may be used by unauthenticated wireless client devices to transmit, for example, an encrypted password identifier that can be used to authenticate the wireless client device using password identifier authentication techniques. The unauthenticated wireless client device may use the cryptographic public key to encrypt other data for transmission to an AP.

### CROSS-REFERENCE TO RELATED APPLICATION

This application claims priority to U.S. Provisional Patent Application No. 63/792,368, filed Apr. 22, 2025, entitled “Password Identifier Encryption,” the entirety of which is incorporated herein by reference.

### TECHNICAL FIELD

The present disclosure relates to wireless networks.

### BACKGROUND

The IEEE 802.11bi amendment for wireless networking aims to protect privacy by avoiding trackability of wireless stations (STAs) from eavesdroppers and other STAs in the same Extended Service Set (ESS).

The current IEEE 802.11 draft allows implementation of password identifiers for Simultaneous Authentication of Equals (SAE) authentication. SAE authentication is a secure password-based authentication and key establishment protocol used in Wi-Fi Protected Access 3 (WPA3). When SAE authentication is used, the non-access point (non-AP) STA sends a password identifier in the clear during the authentication. This password identifier is used by the infrastructure to determine which of the supported passphrases the device is using. This is intended to be used for personal pre-shared key (PSK) use cases. The password identifier is personally identifiable information (PII) that should be protected.

### BRIEF DESCRIPTION OF THE DRAWINGS

FIG. 1 illustrates a block diagram of a wireless network that includes wireless clients and access points (APs) and in which an AP can advertise a cryptographic public key (or availability of the key) to unassociated wireless clients for use in securely transmitting data to the AP prior to association, according to an embodiment.

FIG. 2 is a flow chart depicting, at a high-level, a method performed by an AP to enable an unauthenticated/unassociated wireless client to securely transmit data to the AP, according to an embodiment.

FIG. 3A depicts an operational flow by which an unassociated wireless client device can obtain a cryptographic public key for use in transmitting encrypted data to an AP, according to one embodiment.

FIG. 3B shows a high-level depiction of a frame that may be a Beacon or Probe Response frame that can carry a cryptographic public key, according to the embodiment of FIG. 3A.

FIG. 4A depicts an operational flow by which an unassociated wireless client device can obtain a cryptographic public key for use in transmitting encrypted data to an AP, according to another embodiment.

FIG. 4B illustrates a high-level depiction of a frame that may serve as a Beacon or Probe Response frame according to the embodiment of FIG. 4A.

FIG. 5 illustrates a flow chart depicting a method performed by an unauthenticated/unassociated wireless client device, according to an embodiment.

FIG. 6 shows a frame generated by an unauthenticated wireless client device.

FIG. 7 illustrates a hardware block diagram of an apparatus or device that may perform functions associated with operations discussed herein in connection with the techniques described for embodiments herein.

### DESCRIPTION OF EXAMPLE EMBODIMENTS

### Overview

Presented herein are techniques that allow for sending encrypted data from an unauthenticated/unassociated wireless client device to an access point. In one embodiment, a method is provided that includes generating, by a wireless access point (AP), a cryptographic public key. The method includes providing, by the wireless AP, the cryptographic public key to an unauthenticated wireless client device. The method further includes receiving, by the wireless AP, from the unauthenticated wireless client device, a frame comprising data that was encrypted by the unauthenticated wireless client device using the cryptographic public key.

This cryptographic public key may be used by unauthenticated wireless client devices to transmit, for example, an encrypted password identifier that can be used to authenticate the wireless client device using password identifier authentication techniques. The unauthenticated wireless client device may use the cryptographic public key to encrypt other data for transmission to an AP.

### Example Embodiments

Techniques are presented herein to enable an unassociated/unauthenticated wireless client device (e.g., station, STA, non-AP) to transmit encrypted data to an AP. There are several use cases for these techniques. One use case involves the need for the wireless client device to encrypt and transmit to the AP a password identifier that enables the AP to authenticate the unauthenticated wireless client device. Another use case involves the wireless client device encrypting content comprising troubleshooting data associated with the inability of the wireless client device to associate with the AP. These use cases are not meant to be limiting, and the techniques presented herein may be used to enable a wireless client device to transmit any encrypted data to an AP when the wireless client is not associated with and authenticated to the AP.

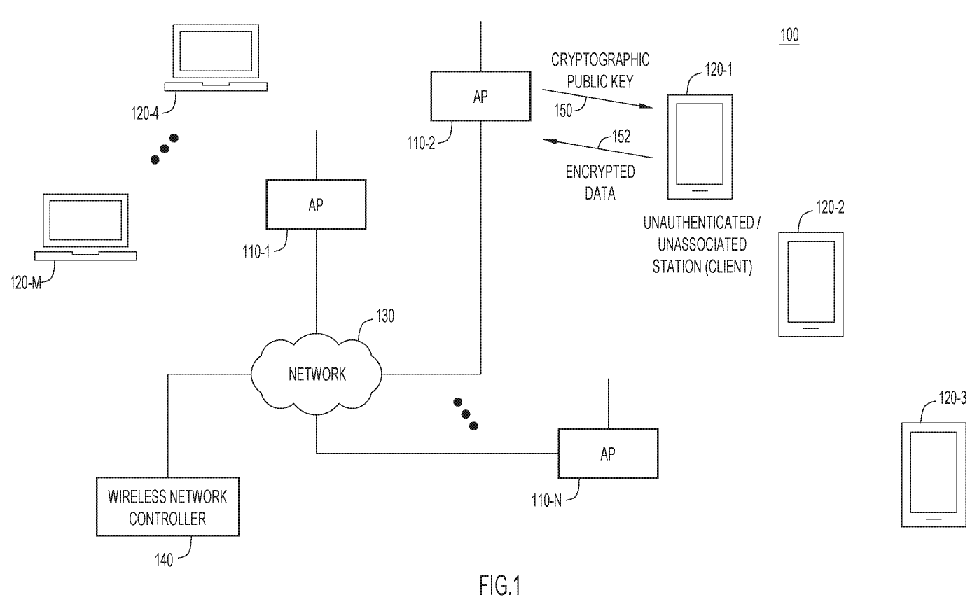

Reference is now made to FIG. 1. FIG. 1 illustrates a wireless network 100 that includes wireless access points (APs) 110-1, 110-2, …, 110-N, and includes wireless stations (STAs) 120-1, 120-2, 120-3, 120-4, …, 120-M. The STAs may also be referred to as wireless clients and non-AP STAs. The APs 110-1 – 110-N may be positioned at various locations around a physical environment, such as in walls or ceilings of a building, in building infrastructure of an outdoor structure (e.g., stadium), etc. The STAs 120-1 to 120-M may associate with one of the APs and may roam between APs.

The STAs 120-1 – 120-M may be mobile devices, such as smartphones, tablets, laptop computers, desktop computers, IoT devices, etc. The wireless network 100 may be an IEEE 802.11 wireless local area network (WLAN).

The APs 110-1 to 110-N may be connected to a network 130. The network 130 may include a wired local area network as well as a wide area network. A wireless network controller 140, also referred to as a WLAN controller (WLC), may be provided which communicates with the APs 110-1 to 110-N via the network 130.

At any given time, one or more of the STAs 120-1 to 120-M may be unauthenticated/unassociated with one or more of the APs 110-1 to 110-N. The term “unconnected” is also used herein to refer to a STA that is unauthenticated/unassociated with an AP. Normally, when a STA is unauthenticated/unassociated with an AP, the STA cannot transmit encrypted data to the AP. Thus, the STA cannot securely share data with the AP even when the STA is unauthenticated/unassociated with the AP.

Accordingly, the techniques presented herein allow for one or more of the APs 110-1 to 110-N to provide a cryptographic public key to a given unauthenticated/unassociated STA to allow that STA to securely transmit data, encrypted with the cryptographic public key, to the AP. The AP can decrypt the encrypted data because it has the cryptographic private key associated with the cryptographic public key.

Thus, as shown in FIG. 1, AP 110-2, for example, at reference numeral 150, transmits a cryptographic public key to STA 120-1, which is unauthenticated/unassociated with AP 110-2. Using the cryptographic public key received from the AP 110-2, the STA 120-1 encrypts data it wishes to send to the AP 110-2, and at 152, transmits the encrypted data in a frame to the AP 110-2, even though the STA 120-1 is not associated with/authenticated to the AP 110-2.

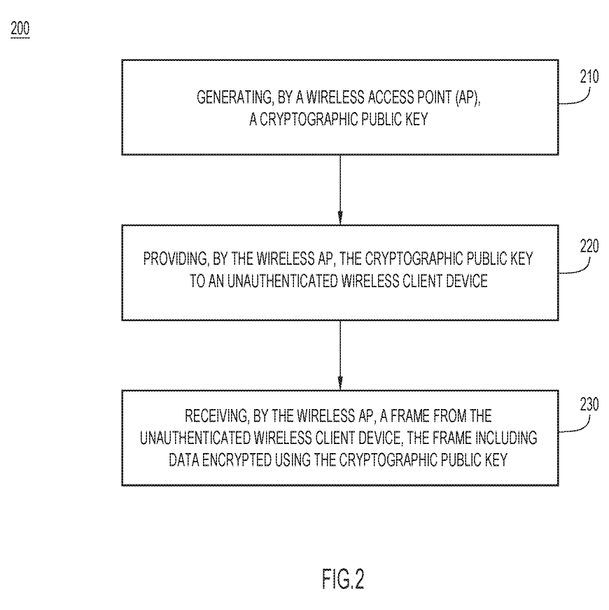

Reference is now made to FIG. 2, with continued reference to FIG. 1. FIG. 2 illustrates a flow chart depicting a method 200, according to an embodiment. The method 200 is performed by an AP, such as one of the APs 110-1 to 110-N shown in FIG. 1. At step 210, the method 200 includes generating, by an AP, a cryptographic public key. The AP maintains a cryptographic private key associated with the cryptographic public key, which the AP can use to decrypt data that has been encrypted with the cryptographic public key. Only the AP has the cryptographic private key, for purposes of the description presented herein.

At step 220, the method 200 involves providing, by the AP, the cryptographic public key to an unauthenticated wireless client device. That is, the wireless client device is unauthenticated/unassociated with the AP when it receives the cryptographic public key from the AP. When the unauthenticated wireless client device has the cryptographic public key, it can encrypt data (content) that it wishes to send to the AP.

At step 230, the method 200 involves the AP receiving a frame from the unauthenticated wireless client device, the frame including data encrypted using the cryptographic public key. As mentioned above, the AP can decrypt the data that has been encrypted with the cryptographic public key using a corresponding cryptographic private key associated with the cryptographic public key. Since only the AP has the cryptographic private key, only the AP can decrypt the data that has been encrypted with the cryptographic public key.

There are numerous ways that the AP can provide the cryptographic public key to an unauthenticated/unassociated wireless client device, as described further below.

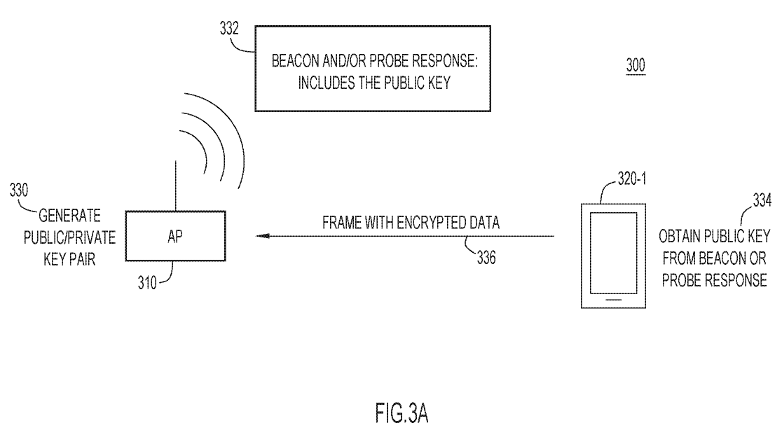

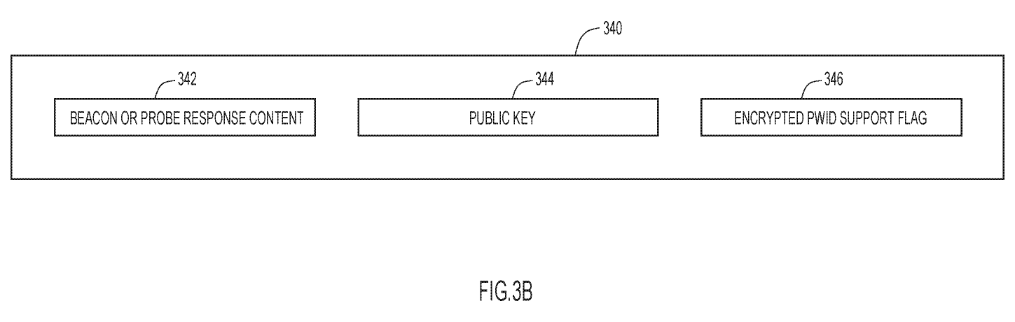

Reference is now made to FIGS. 3A and 3B.

FIG. 3A shows a simplified example of a wireless network including an AP 310 and STAs 320-1, and depicting examples of an operational flow 300 according to example embodiments. STA 320-1 is unassociated/unauthenticated to the AP 310. At 330, the AP generates a cryptographic public-private key pair. In one example, the cryptographic public-private key pair is an Elliptic Curve Cryptography (ECC) public-private key pair. ECC cryptographic key pairs have significant security and are robust against attacks. The length of this key may vary depending on implementation. In some examples, a key of 256 bits can satisfy security requirements (because of ECC cryptographic strength). The cryptographic public-private key pair can be even stronger, such as based on techniques that are post-quantum computing (PQC) resistant.

The AP 310 makes the cryptographic public key (e.g., ECC public key) available to all unauthenticated/unassociated STAs that can receive signals from the AP 310. To make the cryptographic public key available, at 332, the AP 310 may transmit a Beacon or a Probe Response frame (in response to a Probe Request) that includes the cryptographic public key. Any number of unauthenticated/unassociated STAs can receive/use the same cryptographic public key at the same time for sending encrypted data to the AP.

Thus, for example, STA 320-1 can receive signals from the AP 310. At 334, the STA 320-1 may obtain the cryptographic public key from the Beacon or Probe Response frame it receives from the AP 310, encrypt data it wishes to send to the AP 310, and at 336, transmit a frame with encrypted data to the AP 310.

FIG. 3B shows a high-level depiction of a frame 340 that may be a Beacon or Probe Response frame. The frame 340 includes one or more fields 342 that carry the typical Beacon or Probe Response content and an information element field 344 that contains the public key. Furthermore, in one use case, the AP 310 advertises in the Beacon and Probe Response frames support of Simultaneous Authentication of Equals (SAE) password identifier (PWID) encryption with a specific flag in its capabilities elements. This flag is shown as an Encrypted PWID Support flag field 346, which may be a single bit to indicate whether or not the AP 310 supports encryption of a password identifier that may be used, for example, for SAE techniques. In one embodiment, the AP 310 broadcasts the public key information element only if a feature requiring/involving the use of such a key (e.g., SAE using an encrypted password identifier) is configured in the wireless network (i.e., on the AP 310).

Returning back to FIG. 3A, the STA 320-1 that receives the Beacon or Probe Response frame 340 can obtain the cryptographic public key, encrypt data it wishes to send to the AP 310 using the cryptographic public key, and send the encrypted data (e.g., the encrypted password identifier) to the AP 310, as shown at step 336.

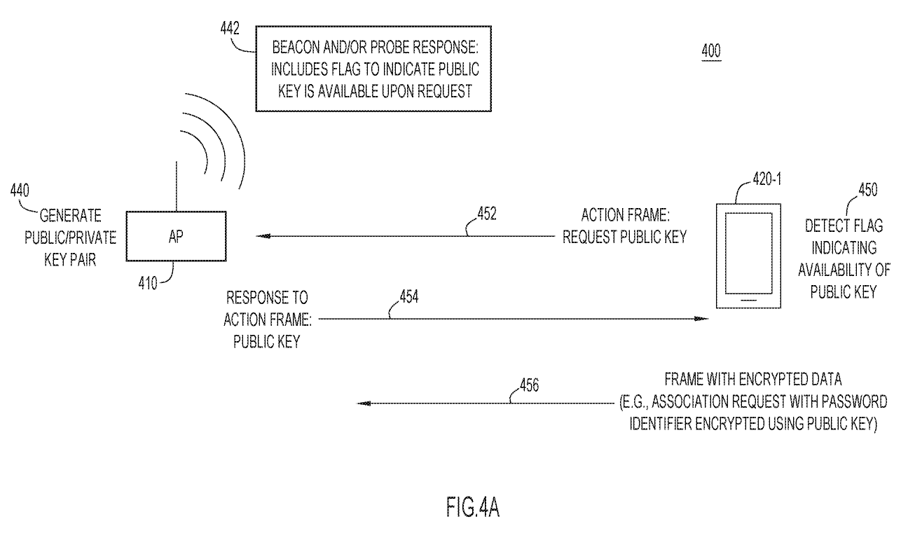

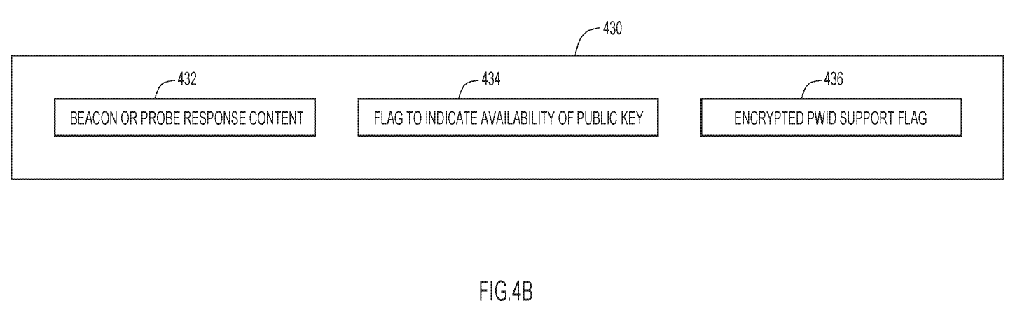

Reference is now made to FIGS. 4A and 4B according to another embodiment. FIG. 4A depicts an operational flow 400 between an AP 410 and a STA 420-1. FIG. 4B illustrates a high-level depiction of a frame 430 that may serve as a Beacon or Probe Response frame according to this embodiment.

In this embodiment, the AP 410 advertises (through a flag in a Beacon or Probe Response frame) that a public key is available upon request. A non-associated STA can request this key with a specific frame (such as an Action frame). This reduces the size of the Beacons and Probe Response frames, but involves an additional exchange to obtain the key. FIG. 4B shows an example of the frame 430, which includes one or more fields 432 that carry the typical Beacon or Probe Response content, a field for a first flag 434 to indicate availability of a public key, and a field for a second flag 436 to indicate whether the AP supports techniques for encrypting a password identifier, called an Encrypted PWID Support flag, similar to that described above in connection with FIG. 3A.

Referring now back to FIG. 4A, at 440, the AP 410 generates the public/private key pair. STA 420-1 is not associated with the AP 410. Instead of including the cryptographic public key in the Beacon or Probe Response frame, at 442, the AP 410 includes a flag in the Beacon or Probe Response frame to indicate that a public key is available upon request. At 450, the STA 420-1 detects in the Beacon or Probe Response, the flag 434 (shown in FIG. 4A) that indicates availability of the public key. At 452, the STA 420-1 transmits an action frame to the AP 410 requesting the public key. At 454, the AP 410 responds with a frame that includes the public key. The STA 420-1 can then encrypt data it wishes to send to the AP 410, and at 456, the STA 420-1 transmits a frame with encrypted data to the AP 410. The AP 410 can decrypt the encrypted data using the corresponding cryptographic private key. In one example, the frame sent at 456 is an association request with a password identifier that is encrypted using the public key for use by the AP 410 to authenticate the STA 420-1, as described above.

A non-AP STA that wishes to associate and authenticate using a password identifier obtains the public key from an AP (via either of the mechanisms depicted in FIGS. 3A or 4A) and uses the public key to encrypt its password identifier at authentication. This ensures the password identifier is never sent in the clear. Because of asymmetric encryption, only the AP that provided the public key to the non-AP STA is able to decrypt the password identifier.

The public key can be used for other exchanges between a non-associated STA (that has not established a pairwise transient key (PTK) with the AP yet) and the AP. This is the case, for example, when a STA is unable to associate with the AP and wants to report this fact to the AP for troubleshooting. Thus, the encrypted data sent at step 336 in FIG. 3A or at step 456 in FIG. 4A may be troubleshooting data that the STA 420-1 sends to the AP 410 when the STA is having trouble associating with the AP 410 to allow the AP 410 to recover that data and assess why the STA 420-1 is not able to associate.

In a variation of the above embodiments described above in connection with FIGS. 3A and 4A, the AP can periodically implement a key rotation in order to improve security. When the AP rotates the public key, only the new public key is accepted and will be able to generate encrypted data that the AP will be able to decrypt. Because the AP can broadcast the public key, STAs do not need to store the public key and there is no risk of using stale keys as long as it uses the most recently broadcasted public key.

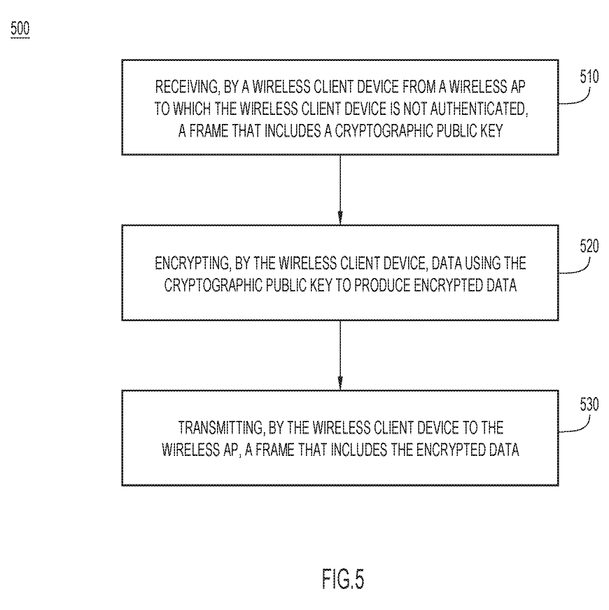

Turning now to FIG. 5, a flow chart is shown depicting a method 500 performed by a wireless client device (e.g., STA). The method 500 includes, at step 510, receiving, by a wireless client device from a wireless AP to which the wireless client device is not authenticated, a frame that includes a cryptographic public key. At step 520, the method 500 includes encrypting, by the wireless client device, data using the cryptographic public key to produce encrypted data. At step 530, the method 500 includes transmitting, by the wireless client device to the wireless AP, a frame that includes the encrypted data.

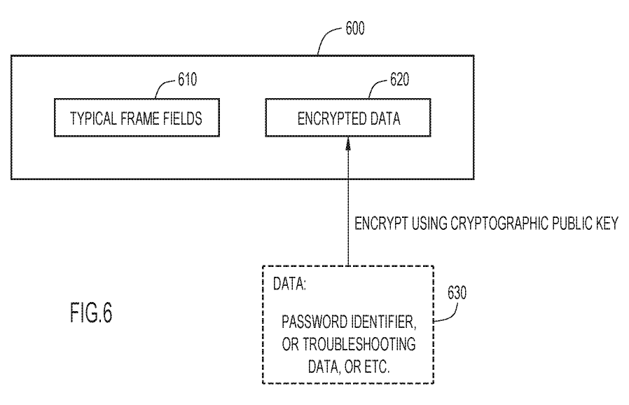

FIG. 6 shows a frame 600 generated by an unauthenticated wireless client device. The frame 600 includes the typical frame fields 610 and a field 620 carrying the encrypted data. The unauthenticated wireless client device generates the encrypted data using the cryptographic public key obtained from a wireless AP. As shown in FIG. 6, the data 630 may include a password identifier or troubleshooting data or any other data that an unauthenticated wireless client device wishes to send to the wireless AP.

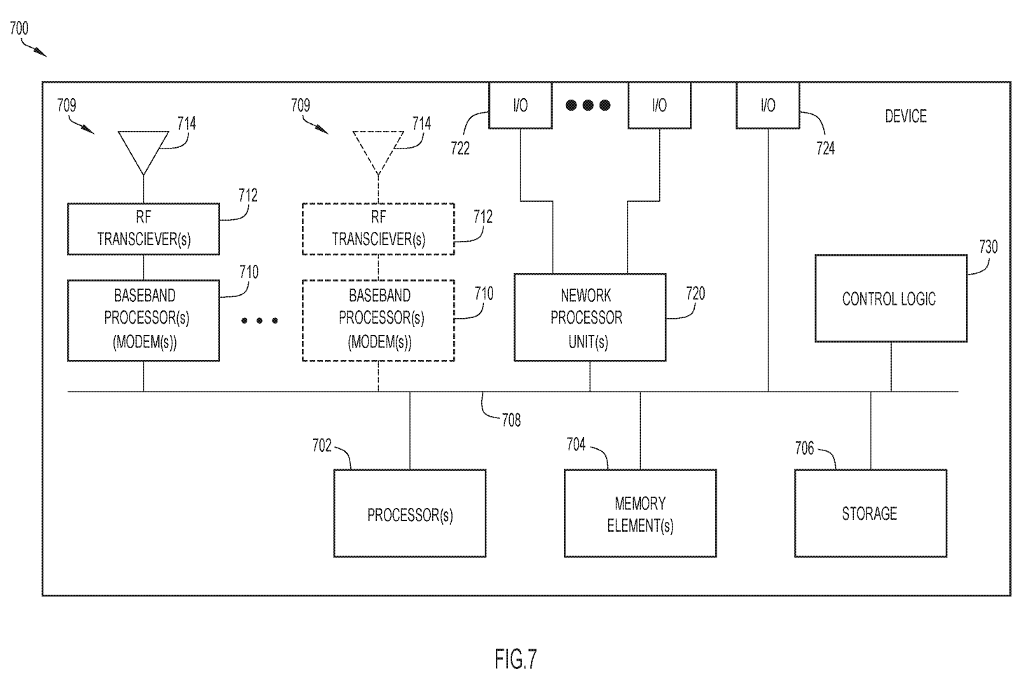

Referring to FIG. 7, FIG. 7 illustrates a hardware block diagram of an apparatus or device 700 that may perform functions associated with operations discussed herein in connection with the techniques described for embodiments herein. Device 700 may be inclusive of any AP and any STA as described for the embodiments herein.

In at least one embodiment, the device 700 may be any apparatus that may include one or more processor(s) 702, one or more memory element(s) 704, storage 706, a bus 708, one or more radio modules 709, each consisting of a baseband processor (modem) 710, one or more RF transceivers 712, and an antenna 714 (or group of antennas). The device 700 may further include one or more network processor unit(s) 720 interconnected with one or more network input/output (I/O) interface(s) 722, one or more I/O interface(s) 724, and control logic 730. In various embodiments, instructions associated with logic for device 700 can overlap in any manner and are not limited to the specific allocation of instructions and/or operations described herein.

In at least one embodiment, processor(s) 702 is/are at least one hardware processor configured to execute various tasks, operations, and/or functions for device 700 as described herein according to software and/or instructions configured for device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of the potential processing elements, microprocessors, digital signal processors, baseband signal processors, modems, PHY, controllers, systems, managers, logic, and/or machines described herein can be construed as being encompassed within the broad term 'processor'.

In at least one embodiment, memory element(s) 704 and/or storage 706 is/are configured to store data, information, software, and/or instructions associated with device 700, and/or logic configured for memory element(s) 704 and/or storage 706. For example, any logic described herein (e.g., control logic 730) can, in various embodiments, be stored for device 700 using any combination of memory element(s) 704 and/or storage 706. Note that in some embodiments, storage 706 can be consolidated with memory element(s) 704 (or vice versa) or can overlap/exist in any other suitable manner.

In at least one embodiment, bus 708 can be configured as an interface that enables one or more elements of device 700 to communicate in order to exchange information and/or data. Bus 708 can be implemented with any architecture designed for passing control, data, and/or information between processors, memory elements/storage, peripheral devices, and/or any other hardware and/or software components that may be configured for device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 720 may enable communication between device 700 and other systems, entities, etc., via network I/O interface(s) 722 (wired and/or wireless) to facilitate operations discussed for various embodiments described herein. In various embodiments, network processor unit(s) 720 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between device 700 and other systems, entities, etc. to facilitate operations for various embodiments described herein. In various embodiments, network I/O interface(s) 722 can be configured as one or more Ethernet port(s), Fibre Channel ports, any other I/O port(s), and/or antenna(s)/antenna array(s) now known or hereafter developed. Thus, the network processor unit(s) 720 and/or network I/O interface(s) 722 may include suitable interfaces for receiving, transmitting, and/or otherwise communicating data and/or information (wired and/or wirelessly) in a network environment.

I/O interface(s) 724 allow for input and output of data and/or information with other entities that may be connected to device 700. For example, I/O interface(s) 724 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

The RF transceiver(s) 712 may perform RF transmission and RF reception of wireless signals via antenna(s) 714, and the baseband processor or modem 710 performs baseband modulation and demodulation, etc. associated with such signals to enable wireless communications for device 700.

In various embodiments, control logic 730 can include instructions that, when executed, cause processor(s) 702 to perform operations, which can include, but are not limited to, providing overall control operations of a computing device; interacting with other entities, systems, etc., described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term 'memory element'. Data/information being tracked and/or sent to one or more entities as discussed herein could be provided in any database, table, register, list, cache, storage, and/or storage structure: all of which can be referenced at any suitable timeframe. Any such storage options may also be included within the broad term 'memory element' as used herein.

Note that in certain example implementations, operations as set forth herein may be implemented by logic encoded in one or more tangible media that are capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 704 and/or storage 706 can store data, software, code, instructions (e.g., processor instructions), logic, parameters, combinations thereof, and/or the like used for operations described herein. This includes memory element(s) 704 and/or storage 706 being able to store data, software, code, instructions (e.g., processor instructions), logic, parameters, combinations thereof, or the like that are executed to carry out operations in accordance with the teachings of the present disclosure.

In some instances, software of the present embodiments may be available via a non-transitory computer usable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a computer-implemented method is provided that may include a method as shown and described herein. In one form, an apparatus as shown and described herein is provided. In one form, a system as shown and described herein is provided. In one form, one or more computer readable storage media encoded with software comprising computer executable instructions is/are provided herein that, when the software is/are executed, is/are operable to perform operations as shown and described herein.

In some aspects, the techniques described herein relate to a method including: generating, by a wireless access point (AP), a cryptographic public key; providing, by the wireless AP, the cryptographic public key to an unauthenticated wireless client device; and receiving, by the wireless AP, from the unauthenticated wireless client device, a frame including data that was encrypted by the unauthenticated wireless client device using the cryptographic public key.

In some aspects, the techniques described herein relate to a method, wherein the cryptographic public key is an Elliptic Curve Cryptography (ECC) key.

In some aspects, the techniques described herein relate to a method, wherein providing, by the wireless AP, the cryptographic public key includes transmitting a beacon or a probe response that includes the cryptographic public key.

In some aspects, the techniques described herein relate to a method, wherein the data is a password identifier that was encrypted by the unauthenticated wireless client device to produce an encrypted password identifier, the method further including: decrypting, by the wireless AP, the encrypted password identifier to obtain the password identifier; and authenticating, by the wireless AP, the unauthenticated wireless client device using the password identifier.

In some aspects, the techniques described herein relate to a method, wherein the beacon or the probe response includes a flag to indicate support for an encrypted password identifier.

In some aspects, the techniques described herein relate to a method, wherein providing, by the wireless AP, the cryptographic public key includes: transmitting a beacon or a probe response that includes a flag indicating availability of the cryptographic public key; receiving from the unauthenticated wireless client device a request for the cryptographic public key; and, in response to the request, transmitting to the unauthenticated wireless client device a response that includes the cryptographic public key.

In some aspects, the techniques described herein relate to a method, wherein the data is a password identifier that was encrypted by the unauthenticated wireless client device to produce an encrypted password identifier, the method further including: decrypting, by the wireless AP, the encrypted password identifier to obtain the password identifier; and authenticating, by the wireless AP, the unauthenticated wireless client device using the password identifier.

In some aspects, the techniques described herein relate to a method, wherein authenticating includes employing a Simultaneous Authentication of Equals (SAE) authentication process to authenticate the unauthenticated wireless client device using the password identifier.

In some aspects, the techniques described herein relate to a method, wherein the beacon or the probe response includes an additional flag to indicate support for an encrypted password identifier.

In some aspects, the techniques described herein relate to a method, wherein the data is troubleshooting data transmitted by the unauthenticated wireless client device to the wireless AP when the unauthenticated wireless client device is unable to authenticate and associate with the wireless AP.

In some aspects, the techniques described herein relate to a method, further including periodically rotating the cryptographic public key to a new cryptographic public key.

In some aspects, the techniques described herein relate to a method including: receiving, by a wireless client device from a wireless access point (AP) to which the wireless client device is not authenticated, a frame that includes a cryptographic public key; encrypting, by the wireless client device, data using the cryptographic public key to produce encrypted data; and transmitting, by the wireless client device to the wireless AP, a frame that includes the encrypted data.

In some aspects, the techniques described herein relate to a method, wherein the frame is a Beacon or Probe Response frame that includes the cryptographic public key.

In some aspects, the techniques described herein relate to a method, wherein the data that the wireless client device encrypts is a password identifier that the AP decrypts and uses for authenticating the wireless client device.

In some aspects, the techniques described herein relate to a method, wherein the frame includes a flag that indicates that the AP supports an encrypted password identifier.

In some aspects, the techniques described herein relate to a method, further including: receiving, by the wireless client device, a beacon or a probe response that includes a flag indicating availability of the cryptographic public key; detecting the flag in the beacon or the probe response; and, based on detecting the flag, transmitting to the AP a frame requesting the cryptographic public key, wherein the frame that includes the cryptographic public key is transmitted by the AP in response to the AP receiving the frame requesting the cryptographic public key.

In some aspects, the techniques described herein relate to a method, wherein the data is troubleshooting data generated by the wireless client device when the wireless client device is unable to authenticate and associate with the wireless AP.

In some aspects, the techniques described herein relate to a wireless access point including: a wireless transceiver configured to transmit and receive wireless signals in a wireless network; a baseband processor configured to perform baseband transmit processing of transmit signals and baseband receive processing of receive signals; and a processor coupled to the baseband processor and to the wireless transceiver, wherein the processor is configured to: generate a cryptographic public key; cause the baseband processor and the wireless transceiver to transmit the cryptographic public key to an unauthenticated wireless client device; and cause the baseband processor and wireless transceiver to receive from the unauthenticated wireless client device a frame including data that was encrypted by the unauthenticated wireless client device using the cryptographic public key.

In some aspects, the techniques described herein relate to a wireless access point, wherein the processor causes the baseband processor and the wireless transceiver to transmit the cryptographic public key by transmitting a beacon or a probe response that includes the cryptographic public key.

In some aspects, the techniques described herein relate to a wireless access point, wherein the data is a password identifier that was encrypted by the unauthenticated wireless client device to produce an encrypted password identifier, wherein the processor is further configured to: decrypt the encrypted password identifier to obtain the password identifier; and authenticate the unauthenticated wireless client device using the password identifier.

In some aspects, the techniques described herein relate to a wireless access point, wherein the beacon or the probe response includes a flag to indicate support for an encrypted password identifier.

In some aspects, the techniques described herein relate to a wireless access point, wherein the processor is further configured to cause the baseband processor and wireless transceiver to: transmit a beacon or a probe response that includes a flag indicating availability of the cryptographic public key; receive from the unauthenticated wireless client device a request for the cryptographic public key; and, in response to the request, transmit to the unauthenticated wireless client device a response that includes the cryptographic public key.

In some aspects, the techniques described herein relate to a wireless access point, wherein the data is a password identifier that was encrypted by the unauthenticated wireless client device to produce an encrypted password identifier, and the processor is further configured to: decrypt the encrypted password identifier to obtain the password identifier; and authenticate the unauthenticated wireless client device using the password identifier.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications, including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used, such as electric, sound, light, infrared, and/or radio, to facilitate communications through one or more networks in accordance with embodiments herein. Communications, interactions, operations, etc., as discussed for various embodiments described herein, may be performed among entities that may be directly or indirectly connected utilizing any algorithms, communication protocols, interfaces, etc. (proprietary and/or non-proprietary) that allow for the exchange of data and/or information.

Communications in a network environment can be referred to herein as 'messages', 'messaging', 'signaling', 'data', 'content', 'objects', 'requests', 'queries', 'responses', 'replies', etc., which may be inclusive of packets. As referred to herein and in the claims, the term 'packet' may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a 'payload', 'data payload', and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of conventional or other databases, data stores, or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in 'one embodiment', 'example embodiment', 'an embodiment', 'another embodiment', 'certain embodiments', 'some embodiments', 'various embodiments', 'other embodiments', 'alternative embodiment', and the like are intended to mean that any such features are included in one or more embodiments of the present disclosure, but may or may not necessarily be combined in the same embodiments. Note also that a module, engine, client, controller, function, logic, or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase 'at least one of', 'one or more of', 'and/or', variations thereof, or the like are open-ended expressions that are both conjunctive and disjunctive in operation for any and all possible combinations of the associated listed items. For example, each of the expressions 'at least one of X, Y and Z', 'at least one of X, Y or Z', 'one or more of X, Y and Z', 'one or more of X, Y or Z' and 'X, Y and/or Z' can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms 'first', 'second', 'third', etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, 'first X' and 'second X' are intended to designate two 'X' elements that are not necessarily limited by any order, rank, importance, temporal sequence, or hierarchy of the two elements. Further, as referred to herein, 'at least one of' and 'one or more of' can be represented using the '(s)' nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained by one skilled in the art and it is intended that the present disclosure encompass all such changes, substitutions, variations, alterations, and/or modifications as falling within the scope of the appended claims.

What is claimed is:

1. A method comprising:
generating, by a wireless access point (AP), a cryptographic public key;
providing, by the wireless AP, the cryptographic public key to an unauthenticated wireless client device; and
receiving, by the wireless AP, from the unauthenticated wireless client device, a frame comprising data that was encrypted by the unauthenticated wireless client device using the cryptographic public key.

2. The method of claim 1, wherein the cryptographic public key is an Elliptic Curve Cryptography (ECC) key.

3. The method of claim 1, wherein providing, by the wireless AP, the cryptographic public key comprises transmitting a beacon or a probe response that includes the cryptographic public key.

4. The method of claim 3, wherein the data is a password identifier that was encrypted by the unauthenticated wireless client device to produce an encrypted password identifier, the method further comprising:
decrypting, by the wireless AP, the encrypted password identifier to obtain the password identifier; and
authenticating, by the wireless AP, the unauthenticated wireless client device using the password identifier.

5. The method of claim 4, wherein the beacon or the probe response includes a flag to indicate support for an encrypted password identifier.

6. The method of claim 1, wherein providing, by the wireless AP, the cryptographic public key comprises:
transmitting a beacon or a probe response that includes a flag indicating availability of the cryptographic public key;
receiving from the unauthenticated wireless client device a request for the cryptographic public key; and
in response to the request, transmitting to the unauthenticated wireless client device a response that includes the cryptographic public key.

7. The method of claim 6, wherein the data is a password identifier that was encrypted by the unauthenticated wireless client device to produce an encrypted password identifier, the method further comprising:
decrypting, by the wireless AP, the encrypted password identifier to obtain the password identifier; and
authenticating, by the wireless AP, the unauthenticated wireless client device using the password identifier.

8. The method of claim 7, wherein authenticating comprises employing a Simultaneous Authentication of Equals (SAE) authentication process to authenticate the unauthenticated wireless client device using the password identifier.

9. The method of claim 7, wherein the beacon or the probe response includes an additional flag to indicate support for an encrypted password identifier.

10. The method of claim 1, wherein the data is troubleshooting data transmitted by the unauthenticated wireless client device to the wireless AP when the unauthenticated wireless client device is unable to authenticate and associate with the wireless AP.

11. The method of claim 1, further comprising periodically rotating the cryptographic public key to a new cryptographic public key.

12. A method comprising:
receiving, by a wireless client device from a wireless access point (AP) to which the wireless client device is not authenticated, a frame that includes a cryptographic public key;
encrypting, by the wireless client device, data using the cryptographic public key to produce encrypted data; and
transmitting, by the wireless client device to the wireless AP, a frame that includes the encrypted data.

13. The method of claim 12, wherein the frame is a Beacon or Probe Response frame that includes the cryptographic public key.

14. The method of claim 12, wherein the data that the wireless client device encrypts is a password identifier that the AP decrypts and uses for authenticating the wireless client device.

15. The method of claim 14, wherein the frame includes a flag that indicates that the AP supports an encrypted password identifier.

16. The method of claim 12, further comprising:
receiving, by the wireless client device, a beacon or a probe response that includes a flag indicating availability of the cryptographic public key;
detecting the flag in the beacon or the probe response; and
based on detecting the flag, transmitting to the AP a frame requesting the cryptographic public key,
wherein the frame that includes the cryptographic public key is transmitted by the AP in response to the AP receiving the frame requesting the cryptographic public key.

17. The method of claim 12, wherein the data is troubleshooting data generated by the wireless client device when the wireless client device is unable to authenticate and associate with the wireless AP.

18. A wireless access point comprising:
a wireless transceiver configured to transmit and receive wireless signals in a wireless network;
a baseband processor configured to perform baseband transmit processing of transmit signals and baseband receive processing of receive signals; and
a processor coupled to the baseband processor and to the wireless transceiver, wherein the processor is configured to:
generate a cryptographic public key;
cause the baseband processor and the wireless transceiver to transmit the cryptographic public key to an unauthenticated wireless client device; and
cause the baseband processor and wireless transceiver to receive from the unauthenticated wireless client device a frame comprising data that was encrypted by the unauthenticated wireless client device using the cryptographic public key.

19. The wireless access point of claim 18, wherein the processor causes the baseband processor and the wireless transceiver to transmit the cryptographic public key by transmitting a beacon or a probe response that includes the cryptographic public key.

20. The wireless access point of claim 19, wherein the data is a password identifier that was encrypted by the unauthenticated wireless client device to produce an encrypted password identifier, wherein the processor is further configured to:
decrypt the encrypted password identifier to obtain the password identifier; and
authenticate the unauthenticated wireless client device using the password identifier.

21. The wireless access point of claim 19, wherein the beacon or the probe response includes a flag to indicate support for an encrypted password identifier.

22. The wireless access point of claim 18, wherein the processor is further configured to cause the baseband processor and wireless transceiver to:
transmit a beacon or a probe response that includes a flag indicating availability of the cryptographic public key;
receive from the unauthenticated wireless client device a request for the cryptographic public key; and
in response to the request, transmit to the unauthenticated wireless client device a response that includes the cryptographic public key.

23. The wireless access point of claim 22, wherein the data is a password identifier that was encrypted by the unauthenticated wireless client device to produce an encrypted password identifier, and the processor is further configured to:
decrypt the encrypted password identifier to obtain the password identifier; and
authenticate the unauthenticated wireless client device using the password identifier.
